(19) United States
(12) Patent Application Publication
(10) Pub. No.: US 2022/0226894 A1
(43) Pub. Date: Jul. 21, 2022

(54) METHOD FOR SINTERING OBJECTS FORMED WITH ALUMINUM POWDER

(71) Applicant: Stratasys Ltd., Rehovot (IL)

(72) Inventors: Shai HIRSCH, Rehovot (IL); Yehoshua SHEINMAN, RaAnana (IL)

(73) Assignee: Stratasys Ltd., Rehovot (IL)

(21) Appl. No.: 17/613,961

(22) PCT Filed: May 11, 2020
(86) PCT No.: PCT/IL2020/050508

§ 371 Date: Nov. 24, 2021

Related U.S. Application Data
(60) Provisional application No. 62/854,351, filed on May 30, 2019.

(51) Int. Cl. B22F 3/10; B22F 10/10

(52) U.S. Cl. CPC B22F 3/1007; B22F 10/10; B22F 2003/1042; B22F 2201/02; B33Y 40/20; B22F 2201/20; B22F 2998/10; B22F 2999/00; B22F 2201/11

(57) ABSTRACT

A method for sintering objects formed with aluminum powder includes forming a shape of an object with aluminum powder, selecting a sintering atmosphere and sintering the object in the sintering atmosphere. The sintering atmosphere includes Nitrogen and one or more of Argon and partial vacuum. The selection is based on a desired balance of degree of shrinkage and mechanical properties to be achieved.

### RELATED APPLICATIONS

This application claims the benefit of priority of U.S. Provisional Patent Application No. 62/854,351 filed on May 30, 2019, the contents of which are incorporated herein by reference in their entirety.

### FIELD AND BACKGROUND OF THE INVENTION

The present invention, in some embodiments thereof, relates to the field of sintering three-dimensional (3D) objects and, more particularly, but not exclusively, to sintering 3D objects formed with aluminum powder.

There are a number of known fabrication processes for forming 3D objects with aluminum powder. Typically, each of these fabrication processes includes a sintering step to strengthen bonding and coalesce the aluminum powder into a solid mass once the object is shaped. One of the challenges associated with the sintering step is oxidation that occurs on the surface of the object producing an aluminum oxide layer, which oxidation hinders the sintering process. A known method to avoid such oxide formation, is to sinter in an inert atmosphere. Nitrogen is often used for this purpose. Objects formed from aluminum powder and sintered in a Nitrogen environment are known to have superior mechanical strength as compared to objects formed from aluminum powder that are sintered in an environment with other gases.

Furthermore, objects formed from aluminum powder are known to shrink during sintering. The extent of the shrinkage for some objects may be predicted and taken into account while ‘shaping’ the object before its formation.

An article entitled “Sintering Behaviour of Aluminium in Different Atmospheres,” published on-line in link: www(dot)researchgate(dot)net/publication/267692094_Sintering_Behaviour_of_Aluminium_in_Different_Atmospheres, describes an investigation of sinterability of pure aluminum powder as investigated in different sintering atmospheres, i.e.: nitrogen, hydrogen, argon, nitrogen/hydrogen and nitrogen/argon gas mixtures, and also in vacuum. The main purpose of this article was to show the influence of the sintering atmosphere on the dimensional changes of aluminum compacts during solid state sintering. To eliminate the effect of alloying additions and of a liquid phase on the sintering behavior, pure aluminum powders were used. The results indicated that enhanced concentration of magnesium within the surface film on powder particles may support sintering of aluminum. Pure nitrogen was concluded to be the only active sintering atmosphere for aluminum which causes shrinkage. The formation of aluminum nitride is thereby a key factor. On the contrary, hydrogen appears to strongly counteract sintering shrinkage, probably due to the trapping of hydrogen to lattice defects.

Example fabrication processes that apply sintering include metal injection molding and additive manufacturing. One example additive manufacturing process is binder jetting. In binder jetting, an inkjet print head moves across a bed of powder, selectively depositing a liquid binding material. This process is repeated over a plurality of layers. When the model is complete, unbound powder is removed. The bound powder may then be sintered to solidify the object.

International Patent Publication No. WO2017/179052 entitled “METHOD AND APPARATUS FOR ADDITIVE MANUFACTURING WITH POWDER MATERIAL,” the contents of which are incorporated herein by reference, discloses a system for building a three-dimensional green compact. The system includes a printing station configured to print a mask pattern on a building surface, a powder delivery station configured to apply a layer of powder material on the mask pattern; a die compaction station for compacting the layer formed by the powder material and the mask pattern; and a stage configured to repeatedly advance a building tray to each of the printing station, the powder delivery station and the die compaction station to build a plurality of layers that together form the three-dimensional green compact. The mask pattern is formed of solidifiable material. At the end of the layer building process, the green compact may be positioned in a second compacting station for final compaction and then transferred to a sintering station for sintering. During the sintering process, the mask built by the printing station burns and the green compact solidifies. The mask burning allows the green compact defined within the layerwise perimeters of the mask to be separated from the portion of the layers outside the perimeters.

International Patent Publication No. WO2018/173048 entitled “METHOD AND SYSTEM FOR ADDITIVE MANUFACTURING WITH POWDER MATERIAL,” the contents of which are incorporated herein by reference, discloses a method for producing a three-dimensional model via additive manufacturing. The method includes building a green block in a layerwise manner with a powder material and a solidifiable non-powder material. The green block includes a green usable model (green body). The solidified non-powder material is removed from the green block to extract the green body from the green block and the density of the green body is increased by applying Cold Isostatic Pressure (CIP). The green body is then sintered to produce a three-dimensional object.

### SUMMARY OF THE INVENTION

According to an aspect of some embodiments of the present invention there is provided a method for reducing shrinkage of an object during a sintering process. The present inventors have found that for some manufacturing processes and/or for some objects, shrinkage during sintering may be undesirable. In some example embodiments, sintering with reduced shrinkage may be advantageous for sintering objects with delicate features or complex geometries that may be prone to deformation during shrinkage. In some example embodiments, sintering with reduced shrinkage may also be suitable for objects manufactured in small quantities, e.g. as one-off items. In such objects, information on how to adjust geometry to compensate for shrinkage during sintering may not be available and may be difficult and/or costly to attain.

According to an aspect of some example embodiments there is provided a method for sintering objects formed with aluminum powder, the method comprising: forming a shape of an object with aluminum powder; selecting a sintering atmosphere comprising Nitrogen and one or more of Argon and partial vacuum based on a desired balance of degree of shrinkage and mechanical properties to be achieved; and sintering the object in the sintering atmosphere.

Optionally, the sintering atmosphere is 20%-80% Nitrogen.

Optionally, the sintering atmosphere is 20%-50% Nitrogen.

Optionally, the object is compacted prior to sintering.

Optionally, the compacting is configured to increase the density of the aluminum powder to 85%-95%.

Optionally, the sintering atmosphere is selected to reduce shrinkage of the object over the sintering process to less than 5%.

Optionally, the sintering atmosphere is selected to reduce shrinkage of the object over the sintering process to less than 2.5%.

Optionally, the sintering atmosphere is selected to confine the shrinkage of the object to be between 2%-3%.

Optionally, the sintering atmosphere is selected to confine the reduction in mechanical strength to 20% in comparison to the mechanical strength with a 100% Nitrogen.

Optionally, the sintering atmosphere is selected to confine the reduction in mechanical strength to 10% in comparison to the mechanical strength with a 100% Nitrogen.

Optionally, the object is sintered in a mix of Nitrogen and Argon.

Optionally, the Nitrogen part is selected based on at least one of the size of the object, the shape of the object and a desired mechanical property of the object.

Optionally, the shape of an object is formed by additive manufacturing.

Optionally, the object is compacted by applying Cold Isostatic Pressure.

Optionally, the object is configured to be physically supported on a support during sintering.

Optionally, the object is immersed or positioned in a bath of inert sand and wherein the bath of the inert sand is the support.

Optionally, the object is immersed or positioned in a bath of balls and wherein the bath of balls is the support.

According to an aspect of some example embodiments there is provided a sintering station comprising: a sintering furnace; a Nitrogen source; an Argon source; an inlet port fluidly connecting an inner volume of the sintering furnace with the Nitrogen source and the Argon source; a first valve configured to control flow of nitrogen into the sintering furnace through the inlet port; a second valve configured to control flow of argon into the sintering furnace through the inlet port; and a controller configured to control each of the first valve and the second valve to obtain a desired mix of Nitrogen and Argon in the sintering furnace.

According to an aspect of some example embodiments there is provided a sintering station comprising: a sintering furnace; a Nitrogen source; a vacuum pump; an inlet port fluidly connecting an inner volume of the sintering furnace with the Nitrogen source; an outlet port fluidly connecting an inner volume of the sintering furnace with the vacuum pump; a valve configured to control flow of nitrogen into the sintering furnace through the inlet port; and a controller configured to control each of the valve and the vacuum pump to obtain a desired mix of Nitrogen and partial vacuum in the sintering furnace.

Optionally, the controller is configured to maintain 20%-80% Nitrogen in the sintering furnace during sintering.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic drawing of an example additive manufacturing system;

FIG. 2 is a simplified schematic drawing of an exemplary per layer building process (side-view);

FIG. 3 is a simplified block diagram of an exemplary cyclic process for building layers;

FIGS. 4A and 4B are two a simplified block diagrams of example sintering stations in accordance with some example embodiments;

FIG. 5 is a simplified schematic drawing showing an example cross-section of an object sintered in a sintering furnace with a support;

FIG. 6 is a simplified flow chart of an example method for sintering an object in accordance with some example embodiments; and

FIG. 7 is an example graph of shrinkage and mechanical strength while sintering with different mixes of Nitrogen and Argon in accordance with some example embodiments.

### DESCRIPTION OF SPECIFIC EMBODIMENTS OF THE INVENTION

The present invention, in some embodiments thereof, relates to the field of sintering objects and, more particularly, but not exclusively, to the sintering of 3D objects formed with aluminum powder.

Known powder metallurgy objects such as aluminum parts formed by methods other than additive manufacturing often have relatively simple shapes and are usually manufactured in large quantities. In such applications, shrinkage may be relatively easily predicted and taken into account during the shaping process so that the final object after sintering has the desired volume, dimensions and shape.

With the emergence of additive manufacturing, objects with more complex geometries may be produced. Aluminum powder may be used to form objects with additive manufacturing. Furthermore, it is economically feasible to produce parts in low quantities, e.g. as one-off items based on additive manufacturing while this may not be the case for other more traditional types of manufacturing methods. These advantages afforded by additive manufacturing are however accompanied by some challenges. One such challenge is maintaining the desired shape of the object during the sintering process.

The methods as described herein may be suitable for objects formed by additive manufacturing and may address challenges associated with sintering objects that are formed by additive manufacturing.

In some example embodiments, sintering with reduced shrinkage may also be suitable for objects that are sintered with physical supports for supporting the shape of the object. However, the physical supports may resist shrinkage and cause cracks in the object as the object attempts to shrink against physical supports that resist shrinking.

While sintering within a Nitrogen environment is known to produce an object with improved mechanical strength, this improvement is commonly accompanied by shrinkage. Objects having complex geometries or delicate features may be subject to deformation due to shrinking. Deformation may occur for example due to thinner portions shrinking at a different rate than thicker portions of the object. Furthermore, corners of the object may also shrink at a different rate than the core of the object.

According to some example embodiments, shrinkage is reduced based on sintering in both a Nitrogen and Argon environment. In some examples, a specific ratio of Nitrogen to Argon is selected to provide a desired balance between object strength (mechanical strength) and an acceptable degree of shrinkage. Alternatively, shrinkage may also be reduced based on sintering with Nitrogen and partial vacuum or with a mix of Nitrogen, Argon and partial vacuum. In some example embodiments, partial vacuum reduces shrinkage and the ratio between Nitrogen and partial vacuum is selected to provide the desired balance between mechanical strength and an acceptable degree of shrinkage e.g. less than 5%. Optionally, prior to sintering, compaction is applied to increase the density of the object formed with aluminum powder and thereby increase the strength of the object. In some example embodiments, the sintering atmosphere is configured to reduce the shrinkage to less than about 5%, e.g. 1%-5%, or 2%-3%.

According to some example embodiments, a ratio or mix between Nitrogen and Argon and/or a vacuum may be selected to provide a favorable balance and/or tradeoff between mechanical strength and shrinkage. In some example embodiments, a selected combination includes 20%-50% Nitrogen and the rest Argon. The relative percentage of Nitrogen and Argon in the sintering atmosphere may be controlled based on controlling the flow rate of each of Nitrogen and Argon from their respective source to the sintering furnace. Optionally, the ratio or mix of Nitrogen with Argon is selected based on one or more of the size and shape of the object. Optionally, the ratio or mix is selected based on a desired mechanical strength for the object. The desired mechanical strength may depend on the intended use of the object.

Although the methods described herein may be particularly suited for preserving shape of an object formed by additive manufacturing, it may also be applied to sintering of objects formed by other manufacturing methods including traditional manufacturing methods.

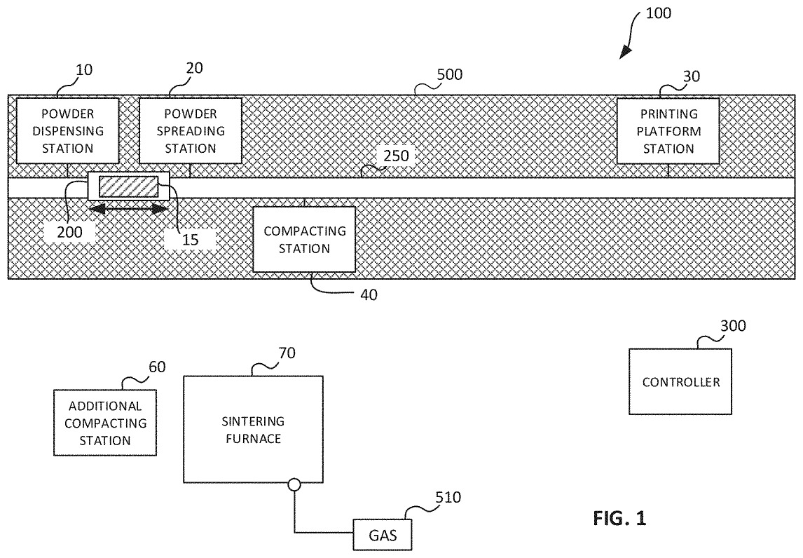

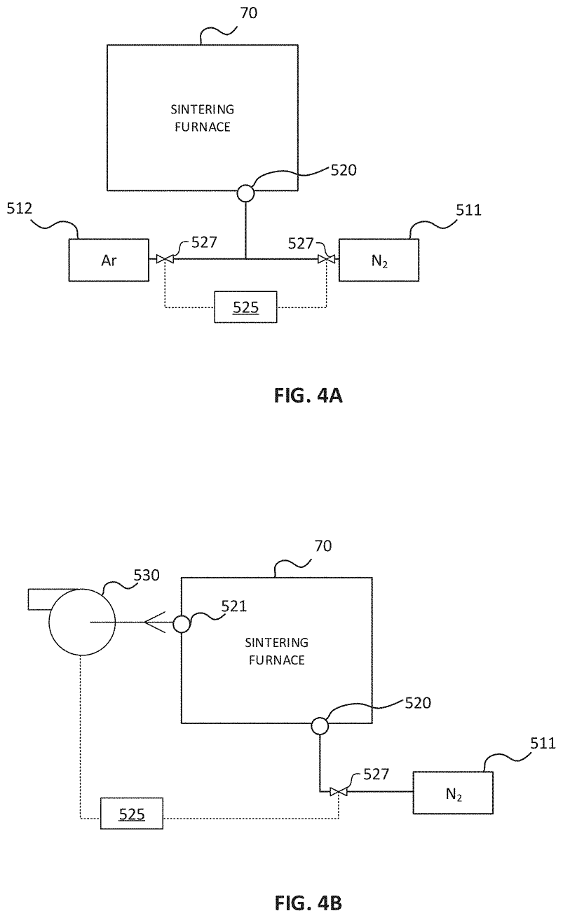

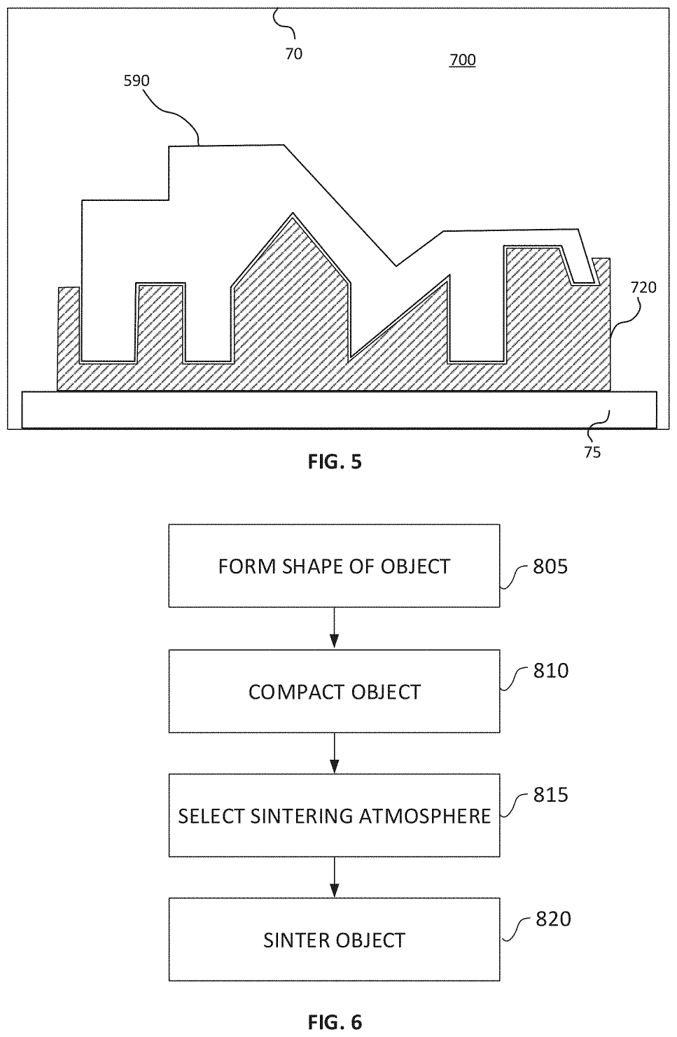

For purposes of better understanding some embodiments of the present invention, as illustrated in FIGS. 4-7 of the drawings, reference is first made to the operation of an additive manufacturing system as illustrated in FIGS. 1-3.

FIG. 1 shows a simplified block diagram of an exemplary additive manufacturing system that may be used to manufacture an object. An additive manufacturing system 100 includes a working platform 500 on which a building tray 200 is advanced through a plurality of stations for building a green block 15, e.g. a block of powder layers, one layer at a time. The green block may include the object in a green compact form, e.g. green body. Typically, a precision stage 250 advances building tray 200 to each of the stations in a cyclic process. The stations may include a printing platform station 30, for printing a pattern of a non-powder solidifiable material, a powder dispensing station 10 for dispensing a powder layer, a powder spreading station 20 for spreading the layer of dispensed powder, and a compacting station 40 for compacting the layer of powder and/or the printed pattern. Typically for each layer, building tray 200 advances to each of the stations and then repeats the process until all the layers have been printed. A controller 300 controls operation of each of the stations on a working platform 500 and coordinates operation of each of the stations with positioning and/or movement of tray 200 on precision stage 250.

The additive manufacturing system may include an additional compacting station 60 to further compress the green block manufactured on working platform 500 after the layer building process is completed.

Green block 15 built on building tray 200 may include a plurality of green usable models (objects in green compact form, i.e. green bodies), e.g. 1-15 models. An example footprint of the block may be 20×20 cm. The green usable models may be extracted from green block 15 and sintered in sintering station 70 as a final step in the manufacturing process.

As used herein, the terms “green block” and “green compact” are interchangeable and refer to a “block”, a “compact”, “compacts of usable models”, “bodies”, and “compacts of support elements” whose main constituent is a bound material, typically in the form of bonded powder, prior to undergoing a sintering process. Further as used herein, “green compacts of usable models,” “objects in green compact form,” and “green bodies” are interchangeable. The terms “object”, “model” and “usable model” as used herein are interchangeable.

Temperatures and duration of sintering typically depends on the powder material used and optionally on the size of the object. Optionally sintering is performed in an inert gas environment. Optionally, an inert gas source 510 is source of nitrogen.

Sintering station 70 and additional compacting station 60 may be standalone stations that are separated from working platform 500. Optionally, green block 15 or the green bodies within green block 15 is manually positioned into additional compacting station 60 and then into sintering station 70, and not via precision stage 250. Optionally, each of additional compacting station 60 and sintering station 70 has a separate controller for operating the respective station.

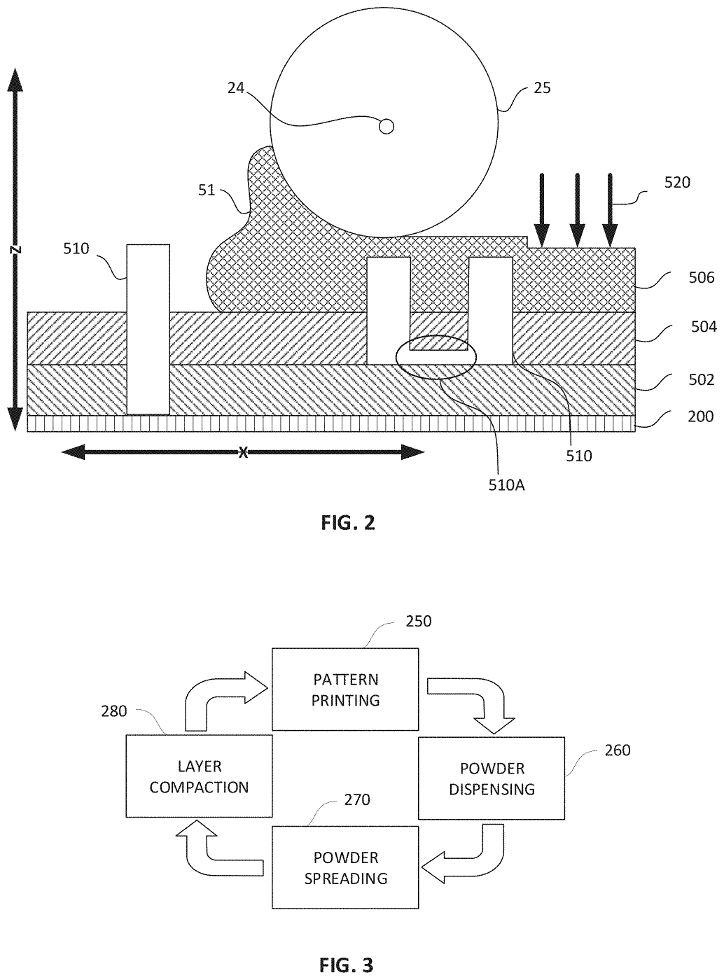

FIG. 2 is a simplified schematic drawing of an exemplary per layer building process. FIG. 2 shows an example third layer 506 in the process of being built over an example first layer 502 and second layer 504. A pattern 510 is dispensed per layer with a three-dimensional printer. Pattern 510 is formed from a solidifiable non-powder material such as a solidifiable ink. Powder 51 is spread over the pattern 510 and across a footprint of a building tray 200 with a roller 25 with an axle 24.

FIG. 3 is a simplified block diagram of an exemplary cyclic process for building green block layers in accordance with some embodiments of the present invention. An object (i.e. a green compact of a usable model) may be constructed layer by layer within a green block in a cyclic process. Each cycle of the cyclic process may include the steps of printing a pattern (block 250) at a printing platform station 30, dispensing (block 260) and spreading (block 270) a powder material over the pattern at a dispensing station 10 and a spreading station 20, and compacting the powder layer including the pattern (block 280) at a compacting station 40. Dispensing and spreading stations 10 and 20 may be combined into one single station also referred to as “powder delivery station”. The pattern may be formed from a solidifiable non-powder material such as a solidifiable ink. Compaction may comprise die compaction per layer. Each cycle forms one layer of the green block and the cycle is repeated until all the layers have been built. Optionally, one or more layers may not require a pattern and the step of printing the pattern (block 250) may be excluded from selected layers. Optionally, one or more layers may not require powder material and the step of dispensing and spreading a powder material (blocks 260 and 270) may be excluded from selected layers. This cyclic process yields a green block, which includes one or more green compacts of usable models, one or more green compacts of support elements and a solidified non-powder material. The green usable models may be extracted from green block and sintered as a final step in the manufacturing process. Optionally, post extraction from the green block and prior to sintering, additional compaction may be performed to compact the green compacts of usable models.

Referring now to FIGS. 4-6 illustrating and describing some example embodiments of the present invention, FIGS. 4A and 4B are two simplified block diagrams of example sintering stations in accordance with some example embodiments. Referring now to FIG. 4A, in some example embodiments, one or more objects may be concurrently sintered in a sintering furnace 70 filed with a selected mixture of inert gases. According to some example embodiments, sintering furnace 70 includes one or more ports 520 through which the inert gases flow into sintering furnace 70 from one or more inert gas sources. In some example embodiments, the inert gas sources include a Nitrogen source 511 and an Argon source 512. Supply from each inert gas sources may be controlled by controller 525 with a dedicated valve(s) 527. According to some example embodiments, controller 525 selectively controls each of valves 527 to obtain a desired proportion of each of Nitrogen and Argon for sintering. In some example embodiments, the proportion of Nitrogen and Argon for sintering is maintained constant throughout the sintering process. Alternatively, the proportion between Nitrogen and Argon may be adjusted and/or changed during the sintering process.

Referring now to FIG. 4B, showing another simplified block diagram of an example sintering station in accordance with some example embodiments. According to some example embodiments, a sintering furnace 70 includes at least one first port 520 through which an inert gas may flow in and at least one second port 521 through which a vacuum may be created based on pumping air or other gas out of sintering furnace 70 with for example a vacuum pump 530.

According to some example embodiments, controller 525 is configured to control the pressure in sintering furnace 70 based on controlling operation of vacuum pump 530 and flow of Nitrogen into sintering furnace 70 from Nitrogen source 511. Air extracted from sintering furnace 70 may be partially replaced with Nitrogen from Nitrogen source 511. Operation of vacuum pump 530 and valve 527 of Nitrogen source 511 may be controlled by controller 525 to obtain a desired inert atmosphere in sintering furnace 70. According to some example embodiments, the desired inert atmosphere is selected to reduce shrinkage. Optionally, the reduced shrinkage is balanced with a desired level of mechanical strength that may typically be provided by presence of Nitrogen in sintering furnace 70.

Reference is now made to FIG. 5 showing a simplified schematic drawing showing an example cross-section of an object sintered in a sintering furnace with a support. According to some example embodiments, an object 590 is supported by a support 720 during sintering. Support 720 may be a bath of inert sand, a bath of small balls or a solid support that is shaped to receive object 590 and support its geometry during sintering. As used herein a ‘ball’ may refer to a spherical element, a particle, a pellet and these terms may be used interchangeably. Support 720 is configured to maintain its shape and size during sintering. Optionally, support 720 is configured to prevent gravitational deformation of object 590 that may otherwise occur during sintering.

Object 590 supported with support 720 may be prone to cracking during sintering. Cracks may occur when object 590 attempts to shrink and the shrinkage is blocked by the geometry of a support 720, e.g. a physical support which is resistant to shrinkage. For example, cracks may occur at various corners, surfaces and/or edges of object 590. According to some example embodiments, cracking is prevented based on controlling the inert atmosphere 700 in sintering furnace 70. In some example embodiments, the inert atmosphere 700 is a defined mix of Nitrogen and Argon. In other example embodiments, the inert atmosphere 700 is Nitrogen in a defined partial vacuum. The presence of Nitrogen imparts mechanical strength to the object being sintered and the presence of Argon or vacuum reduces shrinkage of object 590 during sintering. The ratio of Nitrogen to one of Argon or partial vacuum is controlled to reduce shrinkage while obtaining adequate mechanical strength based on the sintering.

FIG. 6 is a simplified flow chart of an example method for sintering an object in accordance with some example embodiments. According to some example embodiments, a shape of an object may be formed with aluminum powder (block 805). In some example embodiments, the shape is formed by an additive manufacturing process and the shaped object is a green object. In some example embodiments, the shaped object, e.g. the green object may be compacted to increase density of the aluminum powder (block 810). In some example embodiments, the density may be increased from 85%-90% to a density of between 95%-99% or up to close to 100%. In some example embodiments, the compacting imparts mechanical strength to the object and reduces the amount of shrinkage during sintering. According to some example embodiments, the sintering environment is selected to provide a desired balance of physical characteristics to the object (block 815). The selected atmosphere may be a mix of Nitrogen and Argon or Nitrogen in a partial vacuum. In some example embodiments, the mix is defined based on one or more of shape of the object(s), size of the object(s), and density of the object prior to sintering. The object(s) are then sintered in the selected atmosphere. More than one object may be sintered concurrently in a sintering furnace.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

Models were printed in the shape of dog bones for testing tensile strength, and in the shape of cubes for measuring density (by the Archimedes method). The models were then sintered using different gas mixtures. Strength and shrinkage were measured. The strength measured was ultimate tensile strength and the shrinkage was calculated as the difference in density (expressed as % of theoretical bulk density) before and after sintering.

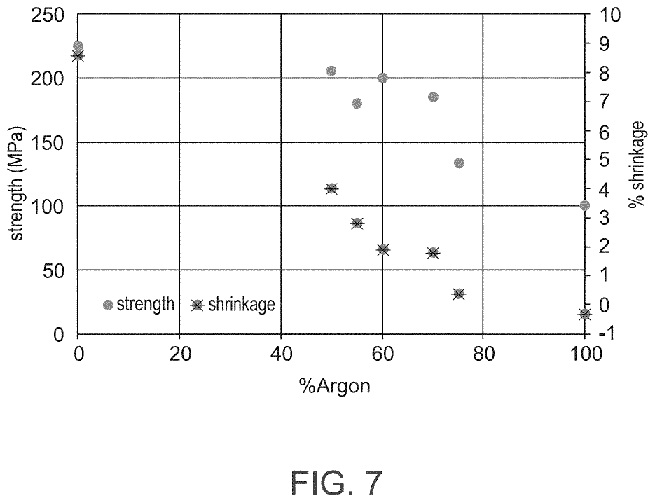

FIG. 7 is an example graph of shrinkage and mechanical strength, i.e. tensile strength while sintering with different mixes of Nitrogen and Argon in accordance with some example embodiments. Table 1 lists numerical values shown in FIG. 7.

It was discovered that by carefully adjusting the ratio of the two gases in the sintering atmosphere, a controlled balance between shrinkage and mechanical properties can be achieved. In the specific example shown, it was found that a mixture of Nitrogen and Argon that includes 30%-50% Nitrogen and the rest Argon may be considered a good compromise between the degree of shrinkage and the mechanical strength. Based on this mixture, shrinkage was significantly reduced, e.g. from about 8% to about 2% and accompanied with a loss in strength of only about 10% to about 20%. By reducing the shrinkage from 8% to about 2%, cracking and deformation for the object tested was found to be negligible.

TABLE 1

| Argon (%) | Nitrogen (%) | Strength (MPa) | Shrinkage (%) |
|---|---|---|---|
| 0 | 100 | 225 | 8.6 |
| 50 | 50 | 205 | 4 |
| 55 | 45 | 180 | 2.8 |
| 60 | 40 | 200 | 1.9 |
| 70 | 30 | 185 | 1.8 |
| 75 | 25 | 134 | 0.4 |
| 100 | 0 | 100 | −0.3 |

The column listing strength was measured from the dog bone models and the column listing shrinkage was measured from the cubes. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method for sintering objects formed with aluminum powder, the method comprising:
forming a shape of an object with aluminum powder;
selecting a sintering atmosphere comprising Nitrogen and one or more of Argon and partial vacuum based on a desired balance of degree of shrinkage and mechanical properties to be achieved; and
sintering the object in the sintering atmosphere.

2. The method of claim 1, wherein the sintering atmosphere is 20%-80% Nitrogen.

3. The method of claim 1, wherein the sintering atmosphere is 20%-50% Nitrogen.

4. The method of claim 1, wherein the object is compacted prior to sintering.

5. The method of claim 4, wherein the compacting is configured to increase the density of the aluminum powder to 85%-95%.

6. The method of claim 1, wherein the sintering atmosphere is selected to reduce shrinkage of the object over the sintering process to less than 5%.

7. The method of claim 6, wherein the sintering atmosphere is selected to reduce shrinkage of the object over the sintering process to less than 2.5%.

8. The method of claim 6, wherein the sintering atmosphere is selected to confine the shrinkage of the object to be between 2%-3%.

9. The method of claim 1, wherein the sintering atmosphere is selected to confine the reduction in mechanical strength to 20% in comparison to the mechanical strength with a 100% Nitrogen.

10. The method of claim 1, wherein the sintering atmosphere is selected to confine the reduction in mechanical strength to 10% in comparison to the mechanical strength with a 100% Nitrogen.

11. The method of claim 1, wherein the object is sintered in a mix of Nitrogen and Argon.

12. The method of claim 1, wherein the Nitrogen part is selected based on at least one of the size of the object, the shape of the object and a desired mechanical property of the object.

13. The method of claim 1, wherein the shape of an object is formed by additive manufacturing.

14. The method of claim 1, wherein the object is compacted by applying Cold Isostatic Pressure.

15. The method of claim 1, wherein the object is configured to be physically supported on a support during sintering.

16. The method of claim 15, wherein the object is immersed or positioned in a bath of inert sand and wherein the bath of the inert sand is the support.

17. The method of claim 15, wherein the object is immersed or positioned in a bath of balls and wherein the bath of balls is the support.

18. A sintering station comprising:
a sintering furnace;
a Nitrogen source;
an Argon source;
an inlet port fluidly connecting an inner volume of the sintering furnace with the Nitrogen source and the Argon source;
a first valve configured to control flow of nitrogen into the sintering furnace through the inlet port;
a second valve configured to control flow of argon into the sintering furnace through the inlet port; and
a controller configured to control each of the first valve and the second valve to obtain a desired mix of Nitrogen and Argon in the sintering furnace.

19. A sintering station comprising:
a sintering furnace;
a Nitrogen source;
a vacuum pump;
an inlet port fluidly connecting an inner volume of the sintering furnace with the Nitrogen source;
an outlet port fluidly connecting an inner volume of the sintering furnace with the vacuum pump;
a valve configured to control flow of nitrogen into the sintering furnace through the inlet port;
a controller configured to control each of the valve and the vacuum pump to obtain a desired mix of Nitrogen and partial vacuum in the sintering furnace.

20. The sintering station according to claim 18, wherein the controller is configured to maintain 20%-80% Nitrogen in the sintering furnace during sintering.
